(19) United States
(12) Patent Application Publication
(10) Pub. No.: US 2026/0037070 A1
(43) Pub. Date: Feb. 5, 2026

(54) ELECTRONIC DEVICE

(71) Applicant: CARUX TECHNOLOGY PTE. LTD., APERIA (SG)

(72) Inventors: Kun-Feng HUANG, Tainan (Tainan Science Park) (TW); Hsien-Chang CHEN, Tainan (Tainan Science Park) (TW); Chia-Hung HSIEH, Tainan (Tainan Science Park) (TW); Hsin-Kai HUANG, Tainan (Tainan Science Park) (TW); Yao-Lin HUANG, Tainan (Tainan Science Park) (TW)

(21) Appl. No.: 19/238,784

(22) Filed: Jun. 16, 2025

(30) Foreign Application Priority Data
Jul. 30, 2024 (CN) 202411025797.0

(51) Int. Cl. G06F 3/01; G06F 3/041; H02N 2/00

(52) U.S. Cl. CPC G06F 3/016; G06F 3/04164; G06F 2203/04105; H02N 2/001

(57) ABSTRACT

An electronic device is provided. The electronic device includes a base, a connecting substrate, a display unit, and an actuator. The connecting substrate is disposed on the base. The display unit is disposed on the connecting substrate. The actuator is disposed on the connecting substrate or on the display unit. The display unit presents a user interface, the user interface includes at least one functional pattern. In the normal direction of the display unit, the actuator overlaps the at least one functional pattern.

### CROSS REFERENCE TO RELATED APPLICATIONS

This Application claims priority of China Patent Application No. 202411025797.0, filed on Jul. 30, 2024, the entirety of which is incorporated by reference herein.

### BACKGROUND

### Field of the Invention

The present invention relates to an electronic device, and, in particular, to an electronic device that includes an actuator to drive the display unit.

### Description of the Related Art

Due to the vigorous development of science and technology, the use of electronic devices is becoming more and more popular nowadays. However, current electronic devices are not satisfactory in all respects (such as their appearance, display effect, reliability, etc.). Therefore, how to solve the above problems is an important issue.

### BRIEF SUMMARY

An embodiment of the present invention provides an electronic device, including a base, a connecting substrate, a display unit, and an actuator. The connecting substrate is disposed on the base. The display unit is disposed on the connecting substrate. The actuator is disposed on the connecting substrate or on the display unit. The display unit presents a user interface, the user interface includes at least one functional pattern. In the normal direction of the display unit, the actuator overlaps the at least one functional pattern.

### BRIEF DESCRIPTION OF THE DRAWINGS

The present invention can be more fully understood by reading the subsequent detailed description and examples with references made to the accompanying drawings, wherein:

FIG. 1 shows a perspective view of an electronic device in accordance with some embodiments of the present disclosure.;

FIG. 2 shows a cross-sectional view of the electronic device in accordance with some embodiments of the present disclosure;

FIGS. 3A through 3E show cross-sectional views of the force-sensing unit in accordance with some embodiments of the present disclosure;

FIGS. 4A through 4C show partial cross-sectional views of the electronic device in accordance with some embodiments of the present disclosure;

FIGS. 5A through 5H show cross-sectional views of the buffer portion of the buffer member in accordance with some embodiments of the present disclosure;

FIG. 6 shows a cross-sectional view of the electronic device in accordance with some embodiments of the present disclosure;

FIG. 7 shows a cross-sectional view of the electronic device in accordance with some embodiments of the present disclosure;

FIG. 8 shows a cross-sectional view of the electronic device in accordance with some embodiments of the present disclosure;

FIG. 9 shows a cross-sectional view of the electronic device in accordance with some embodiments of the present disclosure; and

FIG. 10 shows a cross-sectional view of the electronic device in accordance with some embodiments of the present disclosure.

### DETAILED DESCRIPTION

The present disclosure may be understood by referring to the following description and the appended drawings. It should be noted that, in order to make it easy for the reader to understand and to make the drawings concise, the drawings in the present disclosure may illustrate a part of the light-emitting unit, and specific elements in the drawings are not drawn based on the actual scale. In addition, the number and the size of each component in the drawings merely serves as an example, and are not intended to limit the scope of the present disclosure. Furthermore, similar and/or corresponding numerals may be used in different embodiments for describing some embodiments simply and clearly, but not represent any relationship between different embodiment and/or structures discussed below.

Certain terms may be used throughout the present disclosure and the appended claims to refer to particular elements. Those skilled in the art will understand that electronic device manufacturers may refer to the same components by different names. The present specification is not intended to distinguish between components that have the same function but different names. In the following specification and claims, the words “including”, “comprising”, “having” and the like are open words, so they should be interpreted as meaning “including but not limited to . . . ”. Therefore, when terms “including”, “comprising”, and/or “having” are used in the description of the disclosure, the presence of corresponding features, regions, steps, operations and/or components is specified without excluding the presence of one or more other features, regions, steps, operations and/or components.

In addition, in this specification, relative expressions may be used. For example, “lower”, “bottom”, “higher” or “top” are used to describe the position of one element relative to another. It should be noted that if a device is flipped upside down, an element that is “lower” will become an element that is “higher”.

When a corresponding component (such as a film layer or region) is referred to as “on another component”, it may be directly on another component, or there may be other components in between. On the other hand, when a component is referred “directly on another component”, there is no component between the former two. In addition, when a component is referred “on another component”, the two components have an up-down relationship in the top view, and this component can be above or below the other component, and this up-down relationship depends on the orientation of the device.

It should be understood that, although the terms “first”, “second” etc. may be used herein to describe various elements, layers and/or portions, and these elements, layers, and/or portions should not be limited by these terms. These terms are only used to distinguish one element, layer, or portion. Thus, a first element, layer or portion discussed below could be termed a second element, layer or portion without departing from the teachings of some embodiments of the present disclosure. In addition, for the sake of brevity, terms such as “first” and “second” may not be used in the description to distinguish different elements. As long as it does not depart from the scope defined by the appended claims, the first element and/or the second element described in the appended claims can be interpreted as any element that meets the description in the specification.

In addition, the term “overlap” discussed in the present disclosure may include completely overlap or partially overlap.

It should be understood that, according to the embodiments of the present disclosure, an optical microscope (OM), a scanning electron microscope (SEM), a film thickness profiler (α-step), an ellipsometer, or other suitable means can be used to measure the depth, thickness, width or height of each component, or the spacing or distance between the components. According to some embodiments, a scanning electron microscope can be used to obtain a cross-sectional structural image including the components to be measured, and the depth, thickness, width or height of each component, or the spacing or distance between the components can be measured.

In addition, a certain error may be present in a comparison with any two values or directions. The terms “about,” “equal to,” “equivalent,” “the same,” “essentially” or “substantially” are generally interpreted as within 10% of a given value or range, or as interpreted as within 5%, 3%, 2%, 1%, or 0.5% of a given value or range.

Furthermore, the term “electrically connected” may be used below. It should be understood that if the present disclosure recites “the first element is electrically connected to the second element,” it may be interpreted as that the first element and the second element are electrically connected to each other and may be synchronously controlled by a single operation, which may include the case “there may be other elements between the first element and the second element to electrically connect the former two,” or include “the first element and the second element are directly electrically connected without other elements.” When it is mentioned in the present disclosure that the first element is “directly electrically connected” to the second element, it may be taken to mean that “the first element and the second element are directly electrically connected without other elements.” In addition, the term “electrically insulated” may be used below. It should be understood that if the present disclosure recites “the first element and the second element are electrically insulated,” it may be interpreted as that the first element and the second element are electrically separated without being connected to each other, nor synchronously controlled by a single operation.

It should be noted that the technical solutions provided by different embodiments below may be interchangeable, combined or mixed to form another embodiment without departing from the spirit of the present disclosure.

Unless defined otherwise, all terms (including technical and scientific terms) used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined in the present disclosure.

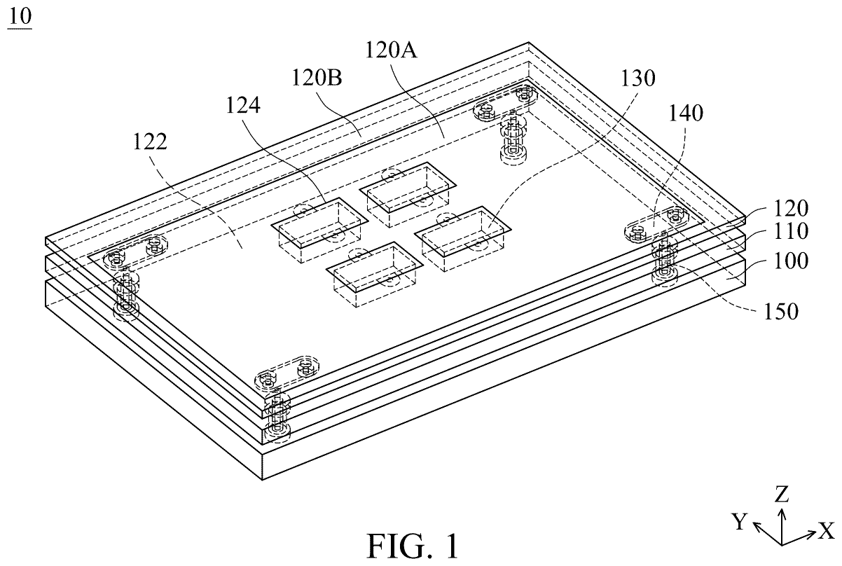

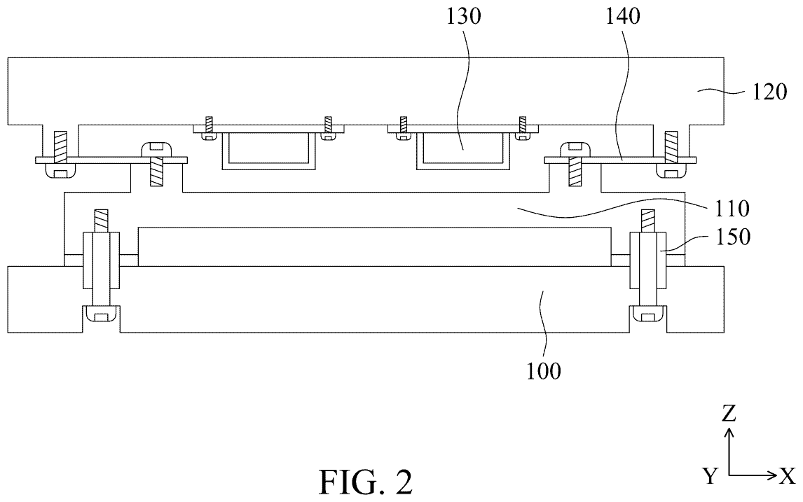

FIG. 1 shows a perspective view of an electronic device 10 in accordance with some embodiments of the present disclosure. FIG. 2 shows a cross-sectional view of the electronic device 10 in accordance with some embodiments of the present disclosure. The electronic device 10 may include a display device, a splicing device, a touch electronic device, a sensing device an antenna device, a package device, a curved electronic device or a non-rectangular electronic device, but the present disclosure is not limited thereto. The electronic device may include, for example, liquid crystal, light-emitting diode, fluorescence, phosphor, other suitable display medium, or a combination thereof, but the present disclosure is not limited thereto. The display device may be a non-self-luminous display device or a self-luminous display device. The electronic device may include electronic components, and the electronic components may include passive components and active components, such as capacitors, resistors, inductors, diodes, transistors, and the like. The diodes may include light-emitting diodes (LED) or photodiodes. The light-emitting diodes may include, for example, organic light-emitting diodes (OLED), mini LEDs, micro LEDs, or quantum dot LEDs, but the present disclosure is not limited thereto. The splicing device may be, for example, a display splicing device, but the present disclosure is not limited thereto. The antenna device may be, for example, a liquid crystal antenna device or an antenna device of varactor diodes, but the present disclosure is not limited thereto. The package device may be used in the wafer-level packaging (WLP) technique or in the panel-level packaging (PLP) technique, for example, chip first process or redistribution layer (RDL) first process. It should be noted that the electronic device may be any combination of the above-mentioned devices, but the present disclosure is not limited thereto. In addition, the electronic device may be a bendable electronic device or a flexible electronic device. Furthermore, the shape of the electronic device may be rectangular, circular, polygonal, shapes with curved edges or other suitable shapes. The electronic device may have peripheral systems such as drive systems, control systems, and light source systems to support display devices or splicing devices.

It should be understood that the content of the present disclosure will be discussed with respect to the partial structure of the electronic device 10 in the following paragraphs, and the present disclosure is not limited thereto. Those skilled in the art should understand that the electronic device 10 may also include other structures or be equipped with suitable electronic components to perform expected functions.

As shown in FIGS. 1 and 2, the electronic device 10 may include a base 100, a connecting substrate 110, a display unit 120 and an actuator 130. The connecting substrate 110 is disposed on the base 100. The display unit 120 is disposed on the connecting substrate 110. The actuator 130 is disposed on the display unit 120 and located between the display unit 120 and the connecting substrate 110. Specifically, in an embodiment, the base 100 can be fixedly connected to, for example, the vehicle body, various brackets on the vehicle, frames, other fixed brackets, fixed devices, or another movable/immovable mechanism or device, but the present disclosure is not limited thereto. The connecting substrate 110 is movably connected to the base 100, whereby the actuator 130 can drive the display unit 120 to vibrate relative to the base 100. In an embodiment, the above-mentioned term “movable” may, for example, indicate that the connecting substrate 110 can be displaced, rotated, vibrated, etc. in any direction relative to the base 100, but the present disclosure is not limited thereto. In some embodiments, the display unit 120 may present a user interface 122 that includes at least one functional pattern 124. In the normal direction (for example, the Z direction) of the display unit 120, the actuator 130 overlaps the functional pattern 124. The display unit 120 includes a display region 120A and a peripheral region 120B surrounding the display region 120A. For example, the display region 120A can be defined as a region where the display unit 120 displays the user interface 122, and the peripheral region 120B can be defined as a region outside the user interface 122 without displaying any information. However, the present disclosure is not limited thereto.

In some embodiments, the base 100 and the connecting substrate 110 may include, for example, a rigid or flexible base material. The materials of the base 100 and the connecting substrate 110 may include, for example, metal, glass, ceramic, sapphire, plastic or other suitable base materials. In some embodiments, the base 100 and the connecting substrate 110 may be single-layered or multi-layered structures. The plastic material can be, for example, polyimide (PI), polyethylene terephthalate (PET), polycarbonate (PC), polyether oxime (PES), polybutylene terephthalate (PBT), polynaphthalene ethylene glycolate (PEN) or polyarylate (PAR), other suitable materials, or combinations thereof. However, the present disclosure is not limited thereto.

In some embodiments, the display unit 120 may be a non-self-luminous display device or a self-luminous display device. The display unit 120 may include electronic components, which may be passive components or active components, such as capacitors, resistors, inductors, diodes, driving components, transistors, etc. The diode may include a light-emitting diode (LED) or a photodiode. The light-emitting diode may include, for example, an organic light-emitting diode (OLED), a mini LED, a micro LED or a quantum dot LED, but the present disclosure is not limited thereto. The display unit 120 may include a substrate and a polarizing film (not shown individually), wherein the polarizing film may be located on the upper and lower sides of the substrate. For example, the substrate may be a flexible substrate or a non-flexible substrate, and the material of the substrate may include, for example, glass, sapphire, ceramic, plastic, or other suitable materials. The plastic material may, for example, be polyimide (PI), polyethylene terephthalate (PET), polycarbonate (PC), polyether oxime (PES), polybutylene terephthalate (PBT), polynaphthalene ethylene glycolate (PEN) or polyarylate (PAR), other suitable materials, or combinations thereof, but the present disclosure is not limited thereto. In some embodiments, the display unit 120 may include a liquid crystal layer (not shown), and the liquid crystal layer may include nematic liquid crystal, smectic liquid crystal, cholesteric liquid crystal, blue phase liquid crystal, or any other suitable liquid crystal material.

For example, the actuator 130 can drive the display unit 120 to vibrate in a horizontal direction (for example, any direction parallel to the X-Y plane) relative to the base 100. However, the present disclosure is not limited thereto. In some embodiments, the actuator 130 may be disposed on the lower surface of the display unit 120. In some embodiments, the actuator 130 may be disposed on the lower surface or the upper surface of the connecting substrate 110. Furthermore, in some embodiments, multiple actuators 130 may be stacked. That is, in the normal direction (for example, the Z direction) of the display unit 120, multiple actuators 130 may overlap each other. In this way, the driving force of the actuator 130 can be enhanced.

The electronic device 10 may include one or more actuators 130. In some embodiments, the actuator 130 may be disposed in the center of the electronic device 10 to effectively drive the display unit 120 to vibrate relative to the base 100, but the present disclosure is not limited thereto. In some embodiments, the actuator 130 may be disposed in any region where the functional pattern 124 is displayed. For example, the display unit 120 can be divided into a plurality of regions, and each of these regions is provided with at least one actuator 130. In this way, vibration can be effectively generated in each region of the display unit 120, or the user can feel touch feedback in a local region. In some embodiments, the actuator 130 can provide inertial energy (for example, via its own vibration) for the display unit 120 to drive the display unit 120 to vibrate relative to the base 100. It should be understood that any actuator 130 that can drive the display unit 120 to vibrate is within the scope of the present disclosure.

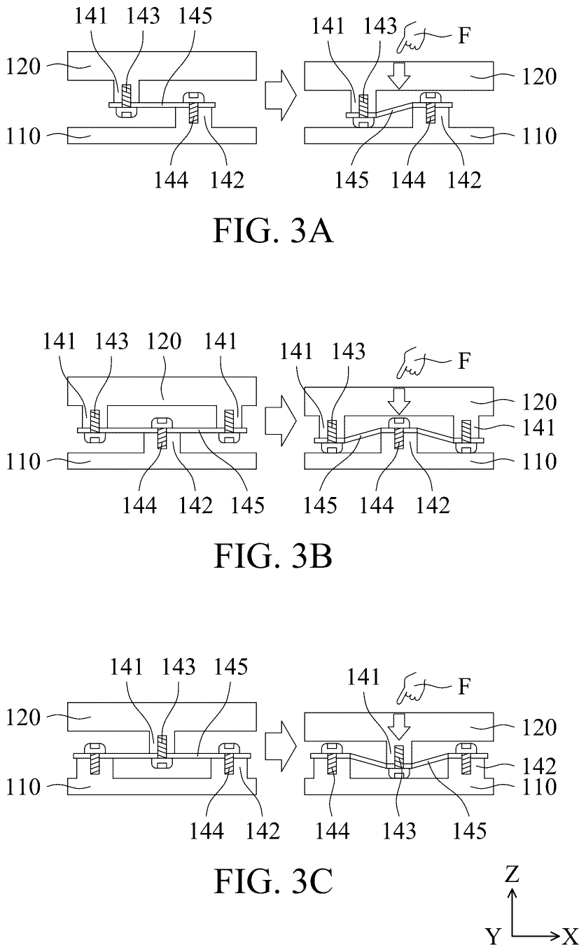

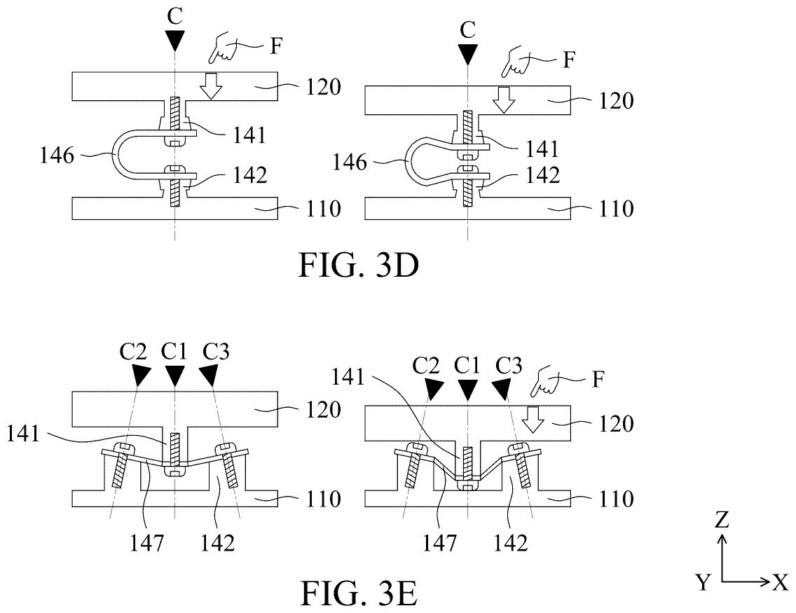

In some embodiments, the electronic device 10 may include force-sensing units 140 that are connected to the display unit 120 and the connecting substrate 110. The force-sensing units 140 can be used to detect the user's force during the operation of the electronic device 10 to provide corresponding feedback to the user. The force-sensing units 140 are located in the display region 120A. In the direction (such as the X direction or the Y direction) that is perpendicular to the normal direction of the display unit 120, the distance between the force-sensing units 140 and the peripheral region 120B is greater than or equal to 0 and less than or equal to 50 mm. As a result, the force-sensing units 140 can effectively detect the user's force during the operation of the electronic device 10, thereby causing the actuator 130 to provide corresponding feedback to the user. In some embodiments, the force-sensing units 140 may be disposed adjacent to each corner of the electronic device 10. In this way, the accuracy of the force-sensing units 140 in detecting the user's force during the operation of the electronic device 10 can be improved, further improving the user experience of the electronic device 10. Various embodiments of the force-sensing units 140 will be further described below with reference to FIGS. 3A through 3E.

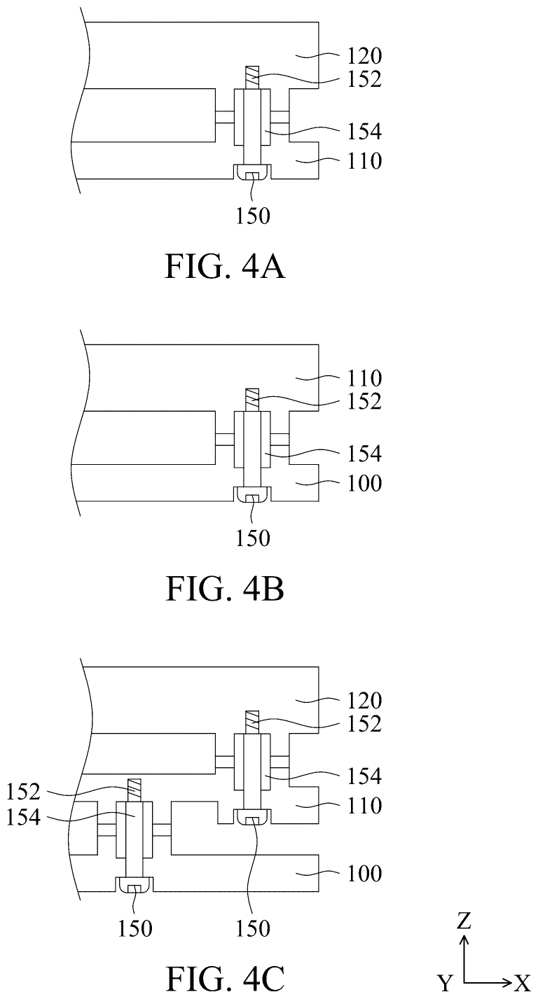

In some embodiments, the electronic device 10 further includes buffer members 150 that is connected to the substrate 110 and the base 100. The buffer members 150 can be used to block vibrations from the environment and reduce the risk of external interference affecting the user's operation of the electronic device 10. In some embodiments, the buffer members 150 may be disposed adjacent to each corner of the electronic device 10 to stabilize the electronic device 10. In some embodiments, the buffer members 150 overlap the force-sensing units 140 in the normal direction (for example, the Z direction) of the display unit 120, but the present disclosure is not limited thereto. Various embodiments of the buffer members 150 will be further described below with reference to FIGS. 4A through 4C.

In addition, it should be understood that the assemblies or elements that are the same as or similar to those mentioned above will be denoted by the same or similar numerals below, and their materials and functions are the same as or similar to those mentioned above, so no more detail will be discussed in the following paragraphs.

FIGS. 3A through 3E show cross-sectional views of the force-sensing unit 140 in accordance with some embodiments of the present disclosure. As shown in FIG. 3A, the force-sensing unit 140 includes an action end 141 and a supporting end 142 opposite to the action end 141. The action end 141 may be connected to the display unit 120, and the supporting end 142 may be connected to the connecting substrate 110. The action end 141 and the supporting end 142 can be offset from and extend in parallel to each other. In other words, in the normal direction (for example, the Z direction) of the display unit 120, the action end 141 and the supporting end 142 may not overlap each other. In some embodiments, the action end 141 can be integrally formed with the display unit 120, and the supporting end 142 can be integrally formed with the connecting substrate 110, thereby simplifying the assembly process of the electronic device 10. However, the present disclosure is not limited thereto. The bridge member 145 is affixed to the action end 141 and the supporting end 142 via fasteners 143 and 144 to form the force-sensing unit 140. For example, the bridge member 145 may be made of metal materials to have sufficient structural strength, but the present disclosure is not limited thereto.

In some embodiments, a force sensor (not shown) may be disposed on the bridge member 145. Since the user exerts the force F to the display unit 120, the display unit 120 would move downward (for example, the Z direction) along with the force F exerted by the user, as shown by the arrow. As a result, the bridge member 145 would be deformed. The force sensor can detect the force exerted by the user to operate the electronic device 10 according to the deformation of the bridge member 145. In this embodiment, the force-sensing unit 140 includes a single set of action end 141 and corresponding supporting end 142. Accordingly, the force-sensing unit 140 can be disposed in a smaller given region, and is suitable for small-sized electronic devices. 10.

It should be noted that the force-sensing unit 140 shown in FIGS. 3B through 3E may include the same or similar structures or portions as those of the force-sensing unit 140 shown in FIG. 3A, and these structures or portions will be denoted by the same or similar numerals and will not be described in detail below for the sake of brevity. As shown in FIG. 3B, the force-sensing unit 140 includes two action ends 141 and a supporting end 142 that is opposite the action ends 141. Similarly, the bridge member 145 is affixed to the action ends 141 and the supporting end 142 via the fasteners 143 and 144 respectively to form the force-sensing unit 140. In this embodiment, the supporting end 142 is located between the two action ends 141. Force sensors (not shown) may be respectively disposed on portions of the bridge member 145 located on both sides of the support end 142. As shown in FIG. 3C, the force-sensing unit 140 includes an action end 141 and two supporting ends 142 opposite to the action end 141. Similarly, the bridge member 145 is affixed to the action end 141 and the supporting ends 142 via the fasteners 143 and 144 respectively to form the force-sensing unit 140. In this embodiment, the action end 141 is located between the two supporting ends 142. Force sensors (not shown) may be respectively disposed on portions of the bridge member 145 located on both sides of the action end 141. By providing multiple action ends 141 and/or supporting ends 142, the user's force for operating the electronic device 10 can be detected more accurately, or the detection range of the force-sensing unit 140 can be expanded.

As shown in FIG. 3D, the force-sensing unit 140 includes an action end 141 and a supporting end 142 that is opposite the action end 141. The action end 141 can be connected to the display unit 120, and the supporting end 142 can be connected to the connecting substrate 110. In this embodiment, the action end 141 and the supporting end 142 may overlap along the central axis C in the normal direction of the display unit 120 (for example, the Z direction). In some embodiments, the bridge member 146 may be U-shaped and affixed to the action end 141 and the supporting end 142 via fasteners 143 and 144 respectively to form the force-sensing unit 140. In some embodiments, a force sensor (not shown) may be disposed on the bridge member 146, and the force sensor may obtain the user's force operating the electronic device 10 according to the deformation of the bridge member 146 caused by the movement of the display unit 120. By arranging the action end 141 and the supporting end 142 that overlap each other, the space required for the force-sensing unit 140 can be reduced, which is beneficial to miniaturization of the electronic device 10.

As shown in FIG. 3E, the force-sensing unit 140 includes an action end 141 and two support ends 142 that are opposite the action end 141. The action end 141 can be connected to the display unit 120, and the supporting ends 142 can be connected to the connecting substrate 110. In this embodiment, the action end 141 can extend along the central axis C1 (for example, parallel to the Z direction), and the two support ends 142 extend along the central axes C2 and C3 (for example, not parallel to the Z direction), and the central axis C1, C2, and C3 are not parallel to each other. For example, if the central axes C1, C2, and C3 are extended, they may intersect above the display unit 120. However, the present disclosure is not limited thereto. In this embodiment, the top surface of the support end 142 may not be parallel to a horizontal plane (for example, the X-Y plane). In some embodiments, the bridge member 147 can be inclined relative to the horizontal plane (such as the X-Y plane) and affixed to the action end 141 and the supporting ends 142 via fasteners 143 and 144 respectively to form the force-sensing unit 140. Similarly, a force sensor (not shown) may be disposed on the bridge member 147, and the force sensor may obtain the user's force for operating the electronic device 10 according to the deformation of the bridge member 147 caused by the movement of the display unit 120. By setting the central axes C1, C2, and C3 of the action end 141 and the supporting ends 142 to extend in different directions, the risk of the force-sensing unit 140 interfering with other components (such as a power supply) can be reduced.

FIGS. 4A through 4C show partial cross-sectional views of the electronic device 10 in accordance with some embodiments of the present disclosure. As shown in FIG. 4A, the buffer member 150 includes a connecting member 152 and a buffer portion 154 that surrounds the connecting member 152. In this embodiment, the connection member 152 of the buffer member 150 connects the display unit 120 and the connecting substrate 110. The buffer portion 154 includes a buffer material to mitigate or absorb vibrations from the external environment and reduce the risk of affecting the accuracy of the user's operation due to vibrations of the display unit 120. At this time, since the buffer member 150 only needs to carry the display unit 120, the restriction specification on the load-bearing capacity of the buffer member 150 can be reduced. The location of the buffer member 150 can be changed as required or in response to the load-bearing capacity of the buffer member 150. As shown in FIG. 4B, the connecting member 152 of the buffer member 150 connects the base 100 and the connecting substrate 110. At this time, because the buffer member 150 is closer to the source of external vibration, it can absorb the vibration from the external environment more effectively. As shown in FIG. 4C, the buffer members 150 can be disposed between the display unit 120 and the connecting substrate 110 and between the base 100 and the connecting substrate 110 to achieve vibration damping effect more completely.

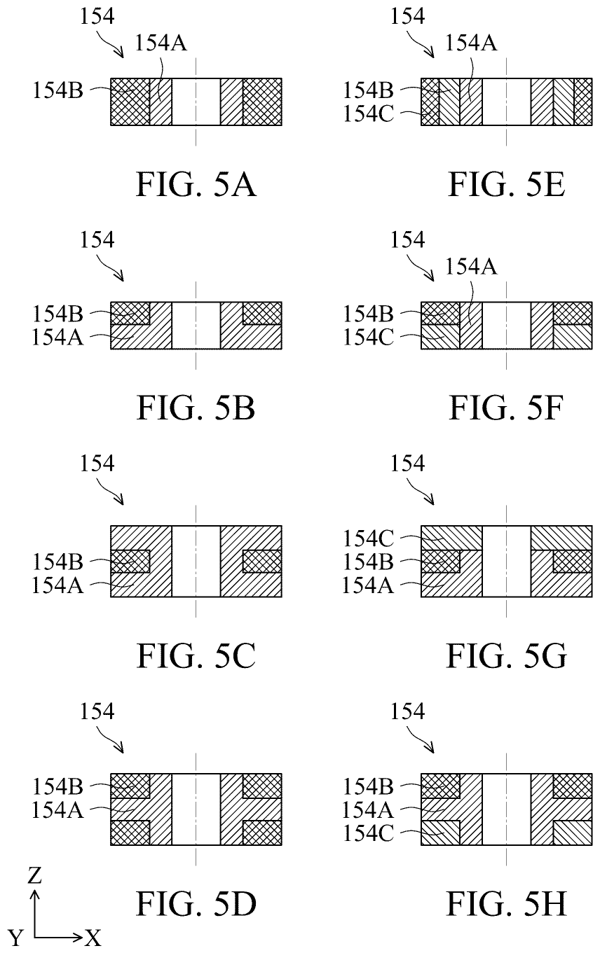

FIGS. 5A through 5H show cross-sectional views of the buffer portion 154 of the buffer member 150 in accordance with some embodiments of the present disclosure. As shown in FIG. 5A, the buffer portion 154 includes two materials with different elastic coefficients. For example, the upper side of the buffer portion 154 faces the display unit 120, and the lower side of the buffer portion 154 faces the base 100. In some embodiments, the buffer portion 154 includes a first material 154A having a first elastic coefficient and a second material 154B having a second elastic coefficient. In some embodiments, the first elastic coefficient of the first material 154A is less than the second elastic coefficient of the second material 154B. In other words, the hardness of the first material 154A is greater than the hardness of the second material 154B. The second material 154B is farther from the center of the buffer member 150 than the first material 154A. As shown in FIG. 5B, the first material 154A can extend below the second material 154B. As shown in FIG. 5C, the first material 154A may extend above the second material 154B. As shown in FIG. 5D, the first material 154A can extend through the second material 154B, that is, a portion of the first material 154A can be sandwiched between the second materials 154B. With the above configuration, the elastic coefficient of the buffer portion 154 in the horizontal direction (such as the X-Y plane) can be greater than the elastic coefficient of the buffer portion 154 in the vertical direction (such as the Z direction), so as to achieve well vibration damping effect.

In addition, as shown in FIG. 5E, the buffer portion 154 also includes a third material 154C with a third elastic coefficient, which is sandwiched between the first material 154A and the second material 154B. In some embodiments, the third elastic coefficient of the third material 154C is between the first elastic coefficient of the first material 154A and the second elastic coefficient of the second material 154B. In other words, the hardness of the third material 154C is between the hardness of the first material 154A and the hardness of the second material 154B. As shown in FIG. 5F, the second material 154B and the third material 154C are located outside the first material 154A, and the third material 154C is disposed below the second material 154B. As shown in FIG. 5G, the third material 154C is located above the first material 154A and the second material 154B, and the first material 154A extends below the second material 154B. As shown in FIG. 5H, the first material 154A can extend through the second material 154B and the third material 154C, that is, a portion of the first material 154A can be sandwiched between the second material 154B and the third material 154C. With the above configuration, the elastic coefficient of the buffer portion 154 in the horizontal direction (such as the X-Y plane) can be greater than the elastic coefficient of the buffer portion 154 in the vertical direction (such as the Z direction), so as to achieve well vibration damping effect.

In particular, in some embodiments, the elastic coefficient is measured and can be positively correlated with tensile properties or compression properties, for example. In some embodiments, the elastic coefficient may be a spring constant, the unit of which is Newton/meter (N/m). In some embodiments, the elastic coefficient may also be Young's modulus, the unit of which is Newton/square meter (N/m²). In some embodiments, the elastic coefficient can be measured by a universal testing machine, or using static methods, dynamic methods, etc., but the method of obtaining the elastic coefficient is not limited thereto. In some embodiments, standard test methods ASTM D1621, ASTM D412, ASTM D695-15, ASTM D638, ISO 527-1, or ASTM E111-17 can be used for testing, but the present disclosure is not limited thereto.

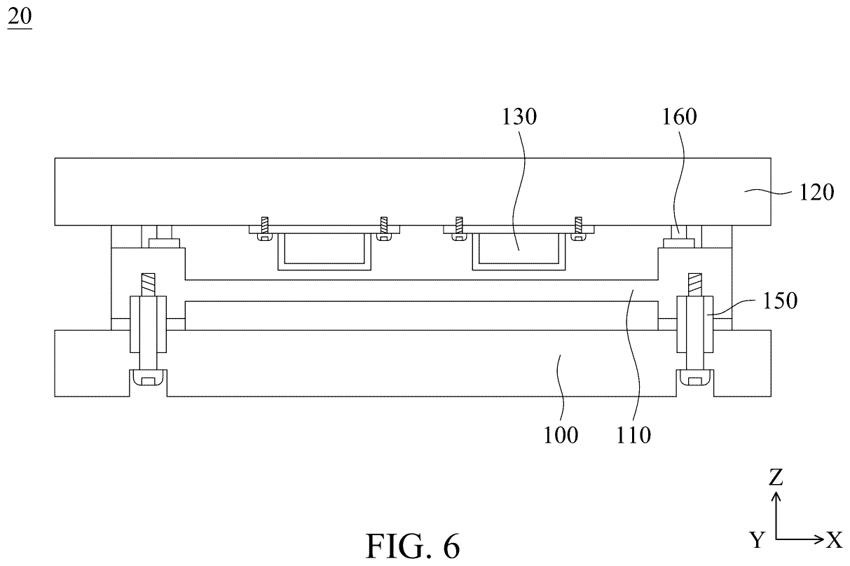

FIG. 6 shows a cross-sectional view of an electronic device 20 in accordance with some embodiments of the present disclosure. It should be noted that the electronic device 20 of this embodiment may include the same or similar structures or portions as those of the electronic device 10 shown in FIGS. 1 and 2, and these structures or portions will be denoted by the same or similar numerals. For the sake of brevity, the details will not be further discussed below. As shown in FIG. 6, the electronic device 20 may include a base 100, a connecting substrate 110, a display unit 120, actuators 130 and buffer members 150. Different from the electronic device 10, the electronic device 20 includes force-sensing units 160 that are disposed between the display unit 120 and the connecting substrate 110. In some embodiments, the force-sensing unit 160 may be a pressure sensor, which deforms due to the force exerted by the user to the display unit 120. As a result, the amount of force exerted by the user to operate the electronic device can be directly obtained. Since the force-sensing unit 160 requires only a relatively small space to be installed, it is beneficial to miniaturization of the electronic device 20.

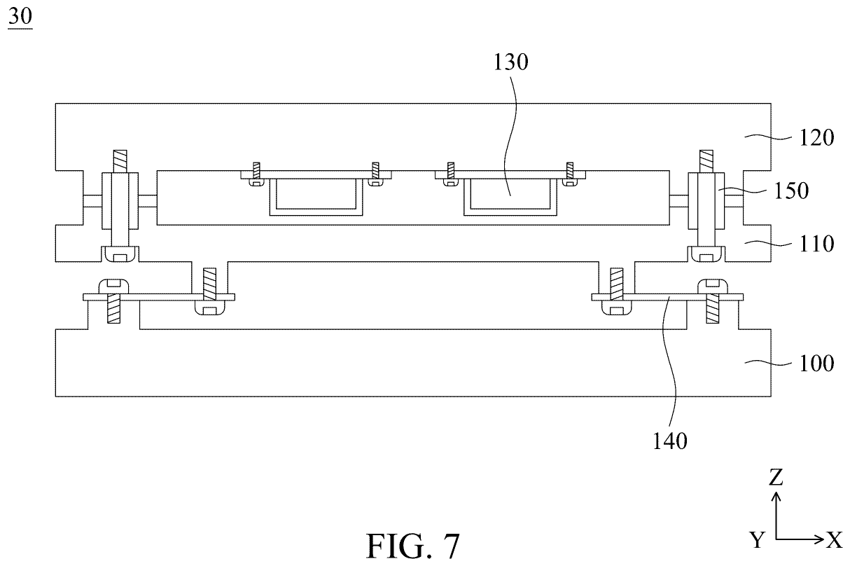

FIG. 7 shows a cross-sectional view of an electronic device 30 in accordance with some embodiments of the present disclosure. It should be noted that the electronic device 30 of this embodiment may include the same or similar structures or portions as those of the electronic device 10 shown in FIGS. 1 and 2, and these structures or portions will be denoted by the same or similar numerals. For the sake of brevity, the details will not be further discussed below. As shown in FIG. 7, the electronic device 30 may include a base 100, a connecting substrate 110, a display unit 120, actuators 130, force-sensing units 140 and buffer members 150. Different from the electronic device 10, the buffer members 150 of the electronic device 30 are disposed between the display unit 120 and the connecting substrate 110, and the force-sensing units 140 are disposed between the connecting substrate 110 and the base 100. In this way, the vibration direction of the connecting substrate 110 is changed to the normal direction of the display unit 120 (or the direction of force exerted by the user). With the above configuration, the bearing pressure of the buffer members 150 can be reduced.

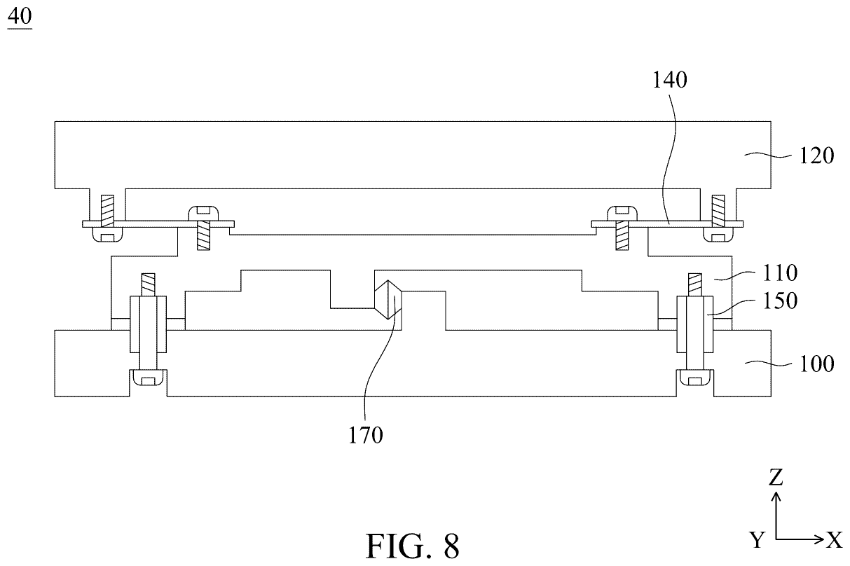

FIG. 8 shows a cross-sectional view of an electronic device 40 in accordance with some embodiments of the present disclosure. It should be noted that the electronic device 40 of this embodiment may include the same or similar structures or portions as those of the electronic device 10 shown in FIGS. 1 and 2, and these structures or portions will be denoted by the same or similar numerals. For the sake of brevity, the details will not be further discussed below. As shown in FIG. 8, the electronic device 40 may include a base 100, a 150. Different from the electronic device 10, the electronic device 40 may include an actuator 170 that is disposed between the connecting substrate 110 and the base 100. In some embodiments, the actuator 170 may be a piezoelectric element. Specifically, a voltage can be supplied to the actuator 170 to cause the actuator 170 to deform (such as expand or contract), thereby driving the connecting substrate 110 (and the display unit 120 located above) to vibrate. In some embodiments, multiple actuators 170 may be disposed, and all configurations with the actuators 170 are included within the scope of the present disclosure.

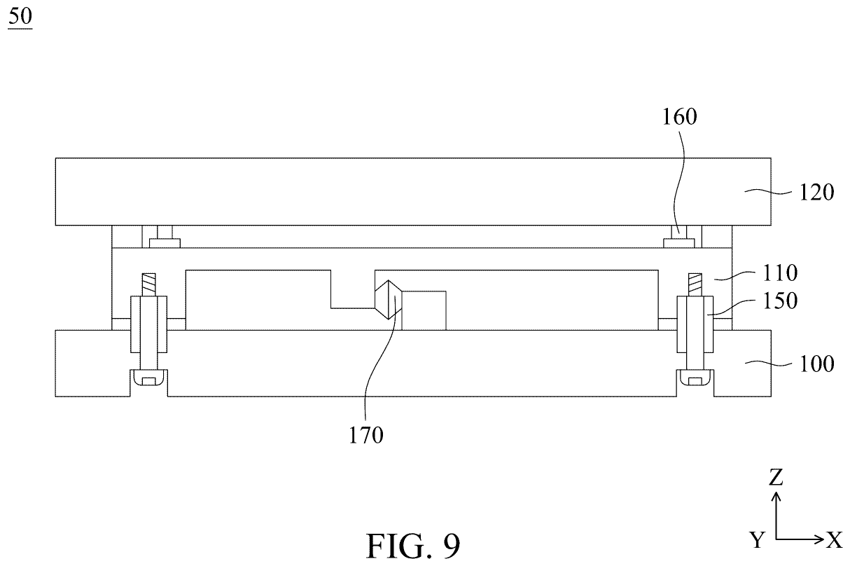

FIG. 9 shows a cross-sectional view of an electronic device 50 in accordance with some embodiments of the present disclosure. It should be noted that the electronic device 50 of this embodiment may include the same or similar structures or portions as those of the electronic device 40 shown in FIG. 8, and these structures or portions will be denoted by the same or similar numerals. For the sake of brevity, the details will not be further discussed below. As shown in FIG. 9, the electronic device 50 may include a base 100, a connecting substrate 110, a display unit 120, an actuator 170 and buffer members 150. Different from the electronic device 40, the electronic device 50 may include force-sensing units 160 that are disposed between the display unit 120 and the connecting substrate 110. The detailed description of the force-sensing units 160 may be referred to FIG. 6 and will not be repeated in the following paragraphs.

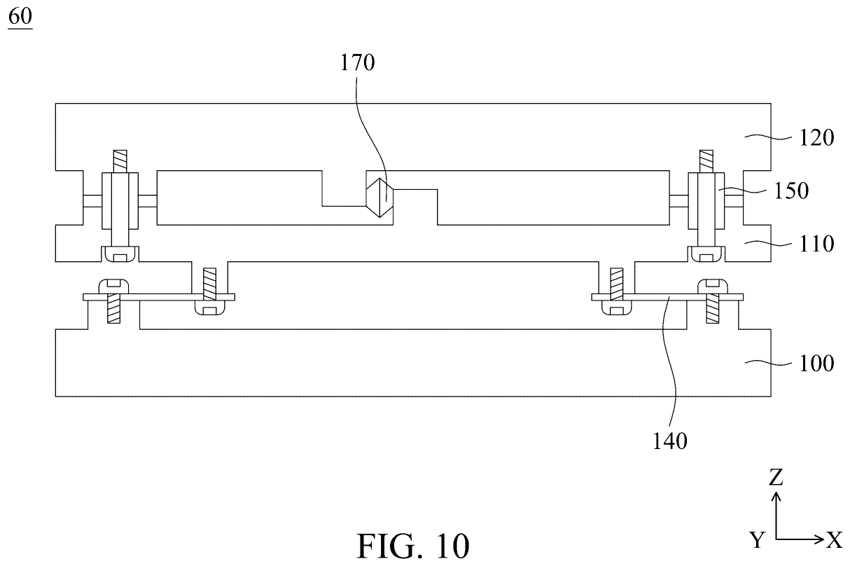

FIG. 10 shows a cross-sectional view of an electronic device 60 in accordance with some embodiments of the present disclosure. It should be noted that the electronic device 60 of this embodiment may include the same or similar structures or portions as those of the electronic device 10 shown in FIGS. 1 and 2, and these structures or portions will be denoted by the same or similar numerals. For the sake of brevity, the details will not be further discussed below. As shown in FIG. 10, the electronic device 60 may include a base 100, a 150. Different from the electronic device 10, the electronic device 60 may include an actuator 170 that is disposed between the display unit 120 and the connecting substrate 110. The detailed description of the actuator 170 may be referred to FIG. 8 and will not be repeated in the following paragraphs.

It should be understood that although the above embodiments only illustrate part of the configuration of the electronic device, those skilled in the art should be able to add other optical layers and/or optical elements in the structure described in the present disclosure according to the teachings of the present disclosure for the purpose of enhancing the display and/or touch effects. These configurations derived from the present disclosure are also included in the scope of the present disclosure. In addition, the present disclosure also provides several different electronic devices. Those skilled in the art should be able to arbitrarily combine/arrange these electronic devices without departing from the teachings of the present disclosure, and these arrangements and combinations are all included within the scope of this disclosure.

As set forth above, embodiments of the present disclosure provide an electronic device including an actuator to drive a display unit. Specifically, the actuator can enable the electronic device to provide user vibration feedback, thereby improving the user experience of the electronic device. The actuator can overlap with the function pattern of the user interface, so that when the user clicks on the function pattern, the electronic device can immediately transmit vibration feedback, so that the user can know that the electronic device has been successfully operated without vision or hearing, improving the convenience for users to operate electronic devices. In addition, the electronic device may include a force-sensing unit for detecting the user's force in operating the electronic device to provide corresponding feedback for the user. In addition, the electronic device may include a buffer member to block vibrations from the environment and reduce the risk of external interference affecting the user's operation of the electronic device.

While the embodiments and the advantages of the present disclosure have been described above, it should be understood that those skilled in the art may make various changes, substitutions, and alterations to the present disclosure without departing from the spirit and scope of the present disclosure. It should be noted that different embodiments may be arbitrarily combined as other embodiments as long as the combination conforms to the spirit of the present disclosure. In addition, the scope of the present disclosure is not limited to the processes, machines, manufacture, composition, devices, methods and steps in the specific embodiments described in the specification. Those skilled in the art may understand existing or developing processes, machines, manufacture, compositions, devices, methods and steps from some embodiments of the present disclosure. Therefore, the scope of the present disclosure includes the aforementioned processes, machines, manufacture, composition, devices, methods, and steps. Furthermore, each of the appended claims constructs an individual embodiment, and the scope of the present disclosure also includes every combination of the appended claims and embodiments.

What is claimed is:

1. An electronic device, comprising:
a base;
a connecting substrate disposed on the base;
a display unit disposed on the connecting substrate; and
an actuator disposed on the connecting substrate or on the display unit,
wherein the display unit presents a user interface, the user interface includes at least one functional pattern, and in a normal direction of the display unit, the actuator overlaps the at least one functional pattern.

2. The electronic device as claimed in claim 1, further comprising a force-sensing unit connected to the connecting substrate and the display unit.

3. The electronic device as claimed in claim 2, wherein the force-sensing unit comprises an action end and a supporting end, the action end is connected to the display unit, and the supporting end is connected to the connecting substrate.

4. The electronic device as claimed in claim 3, wherein in the normal direction of the display unit, the action end is offset from the supporting end.

5. The electronic device as claimed in claim 3, wherein the force-sensing unit comprises a bridge member affixed to the action end and the supporting end.

6. The electronic device as claimed in claim 5, wherein the bridge member is made of a metal material.

7. The electronic device as claimed in claim 5, wherein the bridge member is U-shaped, and in the normal direction of the display unit, the action end overlaps the supporting end.

8. The electronic device as claimed in claim 3, wherein a central axis of the action end is substantially parallel to a central axis of the supporting end.

9. The electronic device as claimed in claim 3, wherein the action end is integrally formed with the display unit, and the supporting end is integrally formed with the connecting substrate.

10. The electronic device as claimed in claim 2, wherein the force-sensing unit comprises an action end and two supporting ends, the action end is located between the two supporting ends, and central axis of the action end and central axes of the two supporting ends are not parallel to each other.

11. The electronic device as claimed in claim 1, further comprising a force-sensing unit connected to the connecting substrate and the base.

12. The electronic device as claimed in claim 1, further comprising a buffer member connecting the connecting substrate and the display unit.

13. The electronic device as claimed in claim 1, further comprising a buffer member connecting the connecting substrate and the base.

14. The electronic device as claimed in claim 1, wherein the display unit comprises a display region and a peripheral region surrounding the display region, the force-sensing unit is located in the display region, and in a direction perpendicular to the normal direction, the distance between the force-sensing unit and the peripheral region is greater than or equal to 0 and less than or equal to 50 mm.

15. The electronic device as claimed in claim 1, further comprising a buffer member and a force-sensing unit disposed on opposite surfaces of the connecting substrate.

16. The electronic device as claimed in claim 15, wherein in the normal direction of the display unit, the buffer member overlaps the force-sensing unit.

17. The electronic device as claimed in claim 15, wherein the buffer member comprises a connecting member and a buffer portion, and the buffer portion surrounds the connecting member.

18. The electronic device as claimed in claim 17, wherein the buffer portion comprises two materials with different elastic coefficients.

19. The electronic device as claimed in claim 18, wherein the two materials comprise a first material with a first elastic coefficient and a second material with a second elastic coefficient, the first elastic coefficient is less than the second elastic coefficient, and the second material is farther from a center of the buffer member than the first material.

20. The electronic device as claimed in claim 1, wherein the actuator is a piezoelectric element.
